(19) United States
(12) Patent Application Publication
(10) Pub. No.: US 2024/0257142 A1
(43) Pub. Date: Aug. 1, 2024

(54) INTENT-AWARE VIRTUAL ASSISTANT CHAT ROUTING

(71) Applicant: FMR LLC, Boston, MA (US)

(72) Inventors: Tito Thomas, Westford, MA (US); Allen Detmer, Patriot, IN (US)

(21) Appl. No.: 18/101,674

(22) Filed: Jan. 26, 2023

(51) Int. Cl. G06Q 30/015; G06F 40/40; H04L 51/02; H04L 51/04

(52) U.S. Cl. CPC G06Q 30/015; G06F 40/40; H04L 51/02; H04L 51/04

(57) ABSTRACT

Methods and apparatuses are described for intent-aware virtual assistant chat routing. A server receives a request from a user of a client device to transfer a chat-based communication session from a virtual assistant application to an agent. The server captures a topic value and a user message from the chat-based session. The server identifies a user intent associated with the user message by applying a trained intent classification model. When a user intent is identified, the server selects an agent to receive the chat-based session based upon the user intent and a complexity value associated with the user intent and connects an agent device associated with the selected agent to the chat-based session. When a user intent is not identified, the server selects an agent to receive the chat-based session based upon the topic value and connects an agent computing device associated with the selected agent to the chat-based session.

### TECHNICAL FIELD

This application relates generally to methods and apparatuses, including computer program products, for intent-aware virtual assistant chat routing.

### BACKGROUND

As computing technology has become commonplace, many organizations have transitioned away from traditional call centers where customer service agents receive telephone calls from customers to answer questions and resolve issues toward software-based electronic communication interfaces such as text-based online chat sessions over the Internet. In order to efficiently manage this form of communication, many organizations are turning to automated conversation service software applications (such as chatbots and virtual assistants (VAs)) as the first line of interaction with end users. These conversation service applications are programmed to automatically parse chat messages received from a user and determine an appropriate response, then generate a response message to the user as part of the conversation flow. In some cases, the conversation service application is able to determine the user's intent relating to a given message or request and use the intent to formulate an appropriate response. Many times, a conversation service software application can resolve the end user's inquiry altogether.

However, in some instances, the conversation service application is unable to provide information that a user is seeking. Eventually, a user may want to connect to a live agent in the chat session so that the user can ask questions specific to their circumstances or receive information that is otherwise unavailable via the conversation service application. Generally, most VA applications are configured to route the chat session to any available customer service agent and do not consider either (i) the specific intent behind the user's live chat request; (ii) the complexity of a given user request, and/or (iii) agent capabilities that are best suited to successfully respond to the user's questions. As a result, the user is routed to an agent that is unable to provide a satisfactory resolution to the customer's inquiry. This necessitates transfer of the chat session to one or more additional live agents before the customer has received appropriate service. As can be appreciated, a customer may quickly get frustrated by this process-leading to dissatisfaction with the chat service and reluctance to use it in the future. Also, inefficient chat routing results in significant additional time and cost for live service agents, which results in reduced capacity and throughput in handling customer requests.

### SUMMARY

Therefore, what is needed are improved computerized methods and systems for live chat session routing in conversation service applications. The techniques described herein advantageously identify user intent via machine learning-based natural language processing in combination with an intent-based complexity determination and user-specific topic selection in order to select a qualified agent for participation in a live chat session. The methods and systems described herein also prioritize agent selection for live chat servicing based upon both agent availability and competence for a given intent in order to make effective chat routing decisions that are predicted to resolve the customer interaction favorably with minimal difficulty.

The invention, in one aspect, features a computer system for intent-aware virtual assistant chat routing. The system comprises a server computing device having a memory that stores computer-executable instructions and a processor that executes the computer-executable instructions. The server computing device receives a request from a user of a client computing device to transfer a chat-based communication session from a virtual assistant application to an agent. The server computing device captures a topic value and a user message from the chat-based communication session. The server computing device identifies a user intent associated with the user message by applying a trained intent classification model to the user message. When a user intent is identified, the server computing device selects an agent to receive the chat-based communication session based upon the user intent and a complexity value associated with the user intent and connects an agent computing device associated with the selected agent to the chat-based communication session. When a user intent is not identified, the server computing device selects an agent to receive the chat-based communication session based upon the topic value and connects an agent computing device associated with the selected agent to the chat-based communication session.

The invention, in another aspect, features a computerized method of intent-aware virtual assistant chat routing. A server computing device receives a request from a user of a client computing device to transfer a chat-based communication session from a virtual assistant application to an agent. The server computing device captures a topic value and a user message from the chat-based communication session. The server computing device identifies a user intent associated with the user message by applying a trained intent classification model to the user message. When a user intent is identified, the server computing device selects an agent to receive the chat-based communication session based upon the user intent and a complexity value associated with the user intent and connects an agent computing device associated with the selected agent to the chat-based communication session. When a user intent is not identified, the server computing device selects an agent to receive the chat-based communication session based upon the topic value and connects an agent computing device associated with the selected agent to the chat-based communication session.

Any of the above aspects can include one or more of the following features. In some embodiments, capturing a topic value comprises presenting a plurality of selectable topic values in the chat-based communication session, detecting user input that corresponds to one of the selectable topic values in the chat-based communication session, and capturing the selected topic value from the chat-based communication session. In some embodiments, capturing a user message comprises presenting an information request message in the chat-based communication session, detecting user input in response to the information request message in the chat-based communication session, and capturing the user input as the user message. In some embodiments, the detected user input comprises a chat message or a spoken utterance.

In some embodiments, identifying a user intent associated with the user message by applying a trained intent classification model to the user message comprises converting the user message into a machine-readable format suitable for input to the trained intent classification model, executing the trained intent classification model using the converted user message to generate an intent classification for the converted user message, and identifying the user intent based upon the intent classification. In some embodiments, selecting an agent to receive the chat-based communication session based upon the user intent and a complexity value associated with the user intent comprises identifying one or more agents as candidates for receiving the chat-based communication session based upon the user intent, determining a confidence level for each of the identified agents using the complexity value, and selecting one of the identified agents to receive the chat-based communication session based upon the confidence level. In some embodiments, the server computing device does not select any of the identified agents when the confidence level for each of the identified agents falls below a threshold.

In some embodiments, the server computing device captures a user context associated with the chat-based communication session and identifies the user intent associated with the user message by applying a trained intent classification model to the user message and the user context. In some embodiments, the user context comprises one or more of: profile information associated with the user of the client computing device, device information associated with the client computing device, or a contact channel associated with the chat-based communication session.

In some embodiments, the server computing device determines an agent availability based upon the captured topic. In some embodiments, determining an agent availability based upon the captured topic comprises determining an agent service window associated with the captured topic, comparing a current time to the agent service window, and determining that no agents are available for the captured topic when the current time is outside the agent service window. In some embodiments, the server computing device presents alternative agent contact information in the chat-based communication session upon determining that no agents are available for the captured topic. In some embodiments, the server computing device ends the chat-based communication session upon determining that no agents are available for the captured topic.

In some embodiments, an agent computing device is concurrently connected to a plurality of chat-based communication sessions with different client computing devices when the complexity value associated with the user intent of each of the plurality of chat-based communication sessions is below a threshold.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for intent-aware virtual assistant chat routing.

FIG. 2 is a flow diagram of a computerized method of intent-aware virtual assistant chat routing.

FIG. 3 is a diagram of an exemplary user interface for a chat-based communication session between a virtual assistant (VA) application and a client computing device.

FIG. 4 is a diagram of an exemplary user interface for a chat-based communication session that shows a user request message.

FIG. 5 is a diagram of an exemplary user interface for the chat-based communication session that shows a list of topics generated by the VA application.

FIG. 6 is a diagram of an exemplary user interface for the chat-based communication session that shows an information request message and a corresponding response from the client computing device.

FIG. 7 is a diagram of an exemplary user interface for the chat-based communication session that shows a message informing the user that a connection to a live agent is in process.

FIG. 8 is a diagram of an exemplary user interface for the chat-based communication session after an agent has been selected and the session has been routed to an agent computing device.

FIG. 9 is a diagram of an exemplary user interface of the chat-based communication session when the VA application determines that no agents are available after receiving a request for a live chat session.

FIG. 10 is a diagram of an exemplary user interface of the chat-based communication session when the VA application determines that no agents are available after receiving a topic selection from the client computing device.

### DETAILED DESCRIPTION

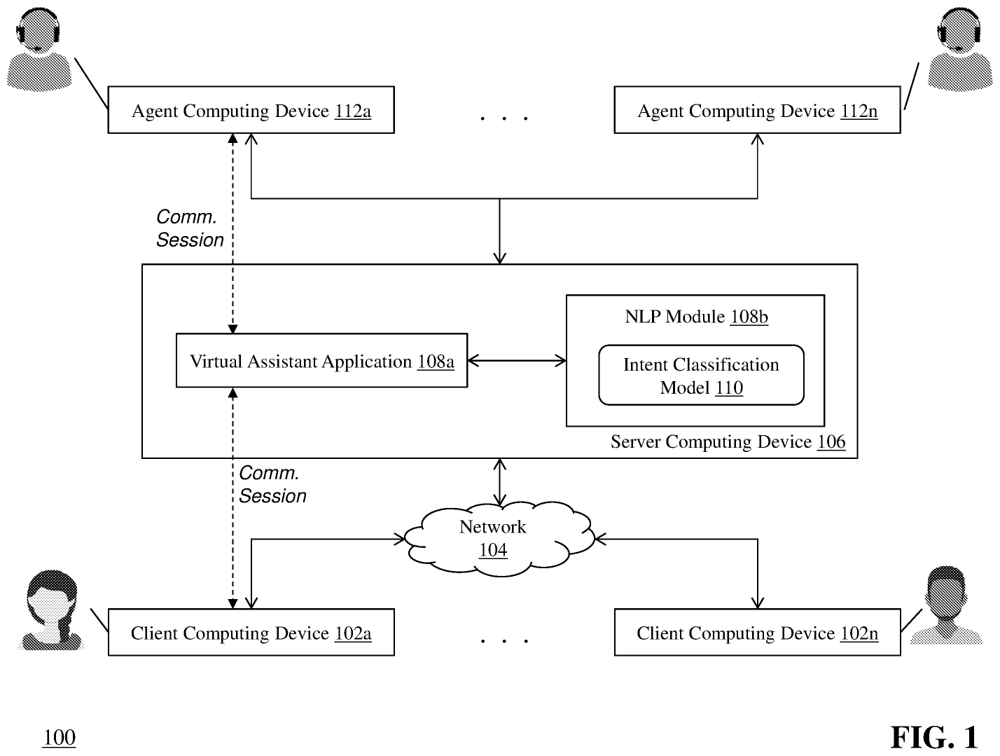

FIG. 1 is a block diagram of system 100 for intent-aware virtual assistant chat routing. System 100 includes remote computing devices 102a-102n, communications network 104, server computing device 106 that includes virtual assistant (VA) application 108a and natural language processing (NLP) module 108b with trained intent classification model 110, and a plurality of agent computing devices 112a-112n.

Client computing devices 102a-102n connect to one or more communications networks (e.g., network 104) in order to communicate with server computing device 106 to provide input and receive output relating to one or more chat-based communication sessions as described herein. Exemplary client computing devices 102a-102n include but are not limited to server computing devices, desktop computers, laptop computers, tablets, mobile devices, smartphones, and the like. It should be appreciated that other types of computing devices that are capable of connecting to the components of system 100 can be used without departing from the scope of invention. Although FIG. 1 depicts two client computing devices 102a-102n, it should be appreciated that system 100 can include any number of client computing devices. In some embodiments, each client computing device 102a-102n is configured with chat application software, which enables client computing devices 102a-102n to establish a chat-based communication session with server computing device 106 via virtual assistant application 108.

Communications network 104 enables remote computing device 102 to communicate with computing device 106. Network 104 is typically comprised of one or more wide area networks, such as the Internet and/or a cellular network, and/or local area networks. In some embodiments, network 104 is comprised of several discrete networks and/or sub-networks (e.g., cellular to Internet).

Server computing device 106 is a device including specialized hardware and/or software modules that execute on a processor and interact with memory modules of server computing device 106, to receive data from other components of system 100, transmit data to other components of system 100, and perform functions for intent-aware virtual assistant chat routing as described herein. Server computing device 106 includes virtual assistant application 108a and NLP module 108b with trained intent classification model 110 that execute on one or more processors of server computing device 106. In some embodiments, VA application 108a and NLP module 108b are specialized sets of computer software instructions programmed onto one or more dedicated processors in server computing device 106.

As can be appreciated, in some embodiments virtual assistant application 108a comprises a conversation service software application (i.e. chatbot) configured to automatically interact with a user at client computing devices 102a-102n in order to gather information and/or respond to inquiries. An exemplary conversation service application can be based upon a natural language processing (NLP) architecture using one or more NLP services which intelligently parse text messages received from client computing devices to understand the context of the message(s) (also called the intent) and how to best respond to it. In some embodiments, VA application 108a can establish a chat-based communication session with client computing devices 102a-102n to enable a user at client computing devices 102a-102n to participate in an automated chat session with VA application 108a. In these embodiments, VA application 108a provides the chat interface for the exchange of messages with client computing devices 102a-102n.

In some embodiments, client computing devices 102a-102n include an application that executes on client computing devices 102a-102n to provide certain functionality to a user of the device. In some embodiments, client computing devices 102a-102n can include a native application installed locally on client computing devices 102a-102n. For example, a native application is a software application (also called an ‘app’) that written with programmatic code designed to interact with an operating system that is native to client computing device 102a-102n and provide information and application functionality (such as a chatbot interface) to a user of client computing device 102a-102n. In the example where client computing device 102a-102n is a mobile device such as a smartphone, the native application software is available for download from, e.g., the Apple® App Store or the Google® Play Store. In some embodiments, the native application includes a software development kit (SDK) module that is executed by a processor of client computing device 102a-102n. In other embodiments, client computing device 102a-102n can include a browser application that runs on the client computing device 102a-102n and connects to one or more other computing devices (e.g., server computing device 106) for retrieval and display of information and application functionality (such as conducting a virtual assistant communication session with VA application 108a). In one example, the browser application enables client computing device 102a-102n to communicate via HTTP or HTTPS with server computing device 106 (e.g., via a URL) to receive website-related content, including one or more webpages, for rendering in the browser application and presentation on a display device coupled to client computing device 102a-102n. Exemplary browser application software includes, but is not limited to, Firefox™, Chrome™, Safari™, and other similar software. The one or more webpages can comprise visual and audio content for display to and interaction with a user.

NLP module 108b comprises a specialized hardware and/or software module (e.g., firmware, middleware, etc.) which executes on one or more processors of server computing device 106 for the purpose of analyzing user messages received from client computing devices 102a-102n during a communication session with VA application 108b and determining a user intent associated with the user messages using, e.g., intent classification model 110. As can be appreciated, a main goal of many virtual assistant applications is to parse incoming user messages, process the messages using NLP to understand the user's input and to determine a user intent for the messages. Then, based upon the determined user intent, the virtual assistant formulates a response to the user messages (e.g., provides information, answers a question, initiates a transaction, etc.) that satisfies the user intent and continues the conversation flow. Many NLP systems (including NLP module 108b) are configured to use a trained intent classification model 110 to determine user intent. In some embodiments, intent classification model 110 is a trained machine learning (ML) algorithm that receives a user message as input and generates a prediction of user intent associated with the user message based upon its training on historical user messages and known intents for those historical messages. In some embodiments, NLP module 108b and trained intent classification model 110 can leverage an external NLP framework such as Google® Dialogflow™, Amazon® Lex™, and Microsoft® Azure Bot™. For example, NLP module 108b can provide domain-specific training data (e.g., user message samples and corresponding user intents) to one or more of these external NLP services for the purpose of training a customized intent classification model (i.e., model 110) that is capable of predicting user intents for a given business context or application. The NLP services return the trained intent classification model 110 to NLP module 108b, which deploys model 110 on server computing device 106 and makes model 110 available to VA application 108a for processing of incoming user messages.

Although VA application 108a and NLP module 108b are shown in FIG. 1 as executing within the same server computing device 106, in some embodiments the functionality of VA application 108a and NLP module 108b can be distributed among one or a plurality of other computing devices that are coupled to server computing device 106. As shown in FIG. 1, server computing device 106 enables VA application 108a and NLP module 108b to communicate with each other in order to exchange data for the purpose of performing the described functions. It should be appreciated that any number of computing devices, arranged in a variety of architectures, resources, and configurations (e.g., cluster computing, virtual computing, cloud computing) can be used without departing from the scope of the invention. The functionality of specification.

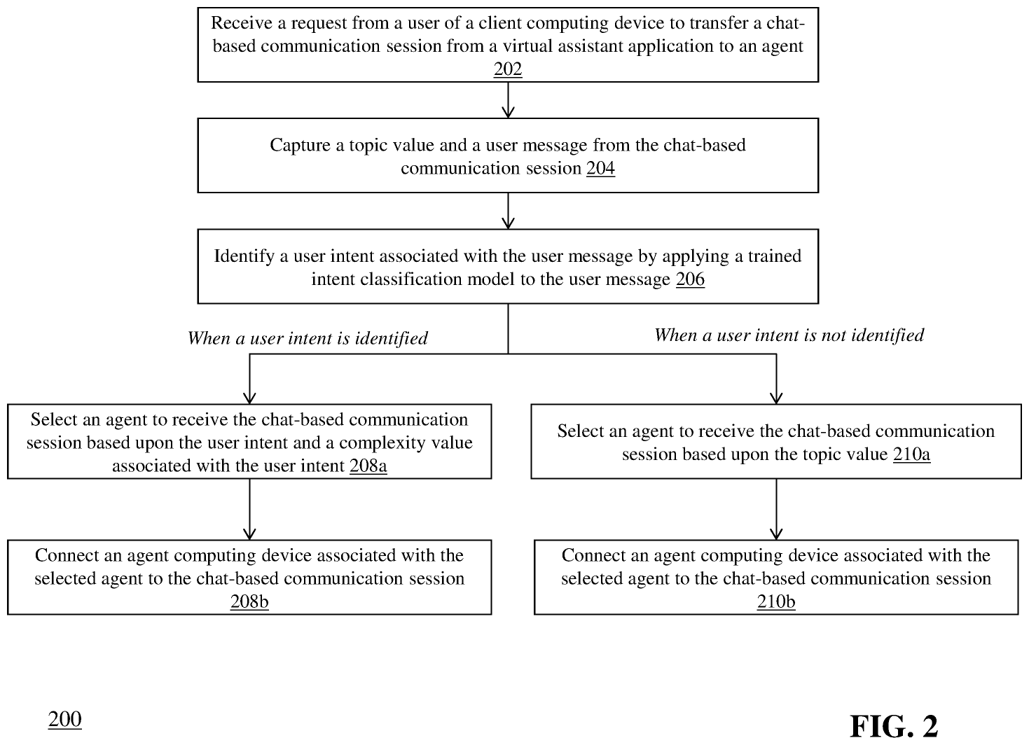

FIG. 2 is a flow diagram of a computerized method 200 of intent-aware virtual assistant chat routing., using system 100 of FIG. 1. A user at client computing device 102a-102n can launch an application (e.g., app, browser) to perform a variety of tasks, including but not limited to information retrieval from local and/or remote data sources. For example, when the application is a browser application, the user can interact with the application to access one or more websites and/or webpages (either internally or externally hosted) in order to view information and submit queries for retrieval of additional information. In one embodiment, the user of client computing device 102a-102n is a customer accessing a company website to retrieve information (e.g., product information, account information, customer service information, and the like).

As can be appreciated, in some instances the information that the customer is seeking may not be readily available or the customer may have additional questions that he or she cannot resolve using only the information provided by the application. In these instances, the customer may want to conduct a chat-based communication session with server computing device 106 via the virtual assistant application 108a. For example, a customer at client computing device 102a-102n may want to connect to VA application 108 for real-time, automated assistance in resolving a problem, performing a transaction, or answering a question. This can be particularly useful in the event that the user's request is received outside of normal customer service business hours. The customer at device 102a-102n can launch an app or a browser to initiate a network connection (e.g., HTTP) to VA application 108a on server computing device 106.

Server computing device 106 establishes a chat-based communication session with client computing device 102a-102n via VA application 108a. When the session is established, server computing device 106 can transmit one or more VA messages to client computing device 102a-102n that greet the user and ask the user how the VA application 108a can help. The user at client computing device 102a-102n can submit one or more user messages that relate to the purpose for initiating the chat-based communication session. VA application 108a receives the user messages and creates a primary dialogue in the communication session between VA application 108a and client computing device 102a-102n. As can be appreciated, a dialogue typically corresponds to a state-based conversation flow between client computing device 102a-102n and VA application 108a, where VA application utilizes NLP module 108b to parse the user messages and determine an intent behind the user messages so that VA application 108a can respond appropriately and perform specific functions (e.g., information retrieval, transaction processing) as necessary.

In some scenarios, during an automated chat session with VA application 108a, there may be a need to connect to a live agent or customer service representative for service. For example, if VA application 108a does not provide satisfactory information or answers, the user may want to speak to a live agent in order to resolve their queries. Typically, in order to request service from a live agent, the user at client computing device 102a-102n enters the request as a user message in the chat session. The user request can take any of a number of different forms or phrases—e.g., “speak with agent,” “contact us,” “live chat,” “talk to real person,” etc. In some embodiments, a user interface provided by VA application 108a as part of the chat-based communication session can include an input feature (e.g., link, prompt, or menu) that, when activated by the user, provides an indication that the user wishes to be connected to a live agent.

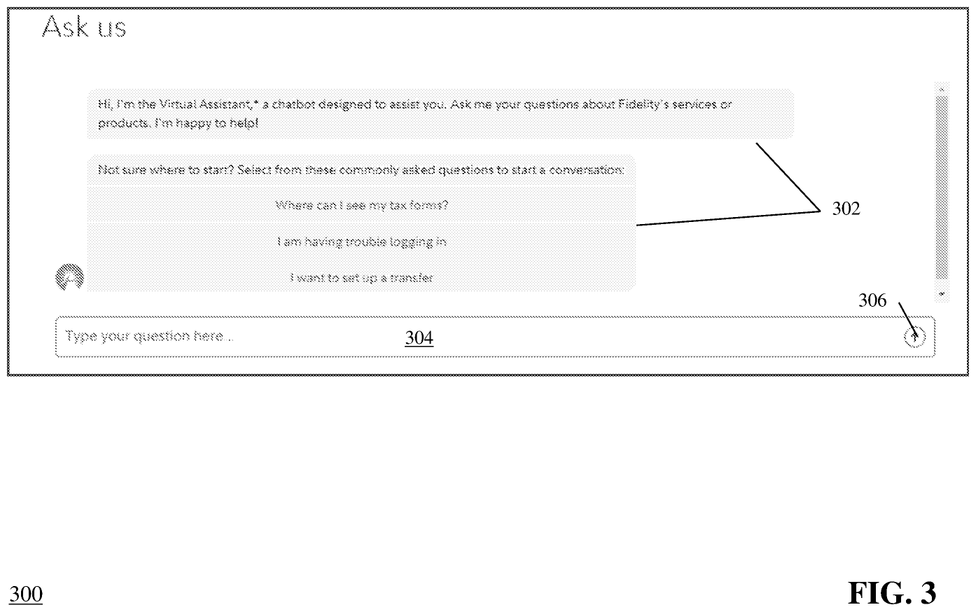

FIG. 3 is a diagram of an exemplary user interface 300 for a chat-based communication session between VA application 108a and client computing device 102a-102n. As shown in FIG. 3, user interface 300 includes introductory messages 302 from VA application 108a to prompt the user at client computing device 102a-102n to interact with VA application 108a. User interface 300 also includes input element 304 that enables the user to enter messages and button 306 that can be activated by the user to transmit the entered message to VA application 108a as part of the chat session.

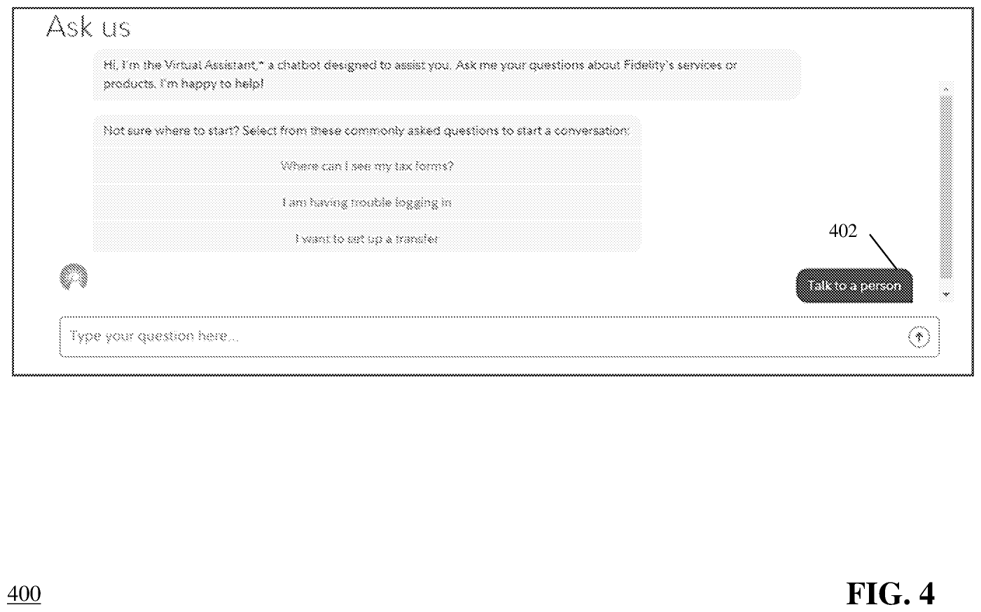

As mentioned above, during the chat session the user may want to connect to a live agent to continue the conversation and receive information or services. IN order to initiate the transfer to a live agent, the user at client computing device 102a-102n can enter a user message that is recognized by VA application 108a as a request to connect to a live agent. VA application 108a receives (step 202) the request to transfer the chat-based communication session from VA application 108a to an agent at agent computing device 112a-112n. FIG. 4 is a diagram of an exemplary user interface 400 for the chat-based communication session that shows the user request message. In this example, the user at client computing device 102a-102n has entered the message 402 (i.e., “Talk to a person”) and submitted the message to VA application 108a. VA application 108a parses the incoming message 402 and determines that the user want to speak with a live agent. In some embodiments, VA application 108a passes the message to NLP module 108b which analyzes the message and determines that a transfer has been requested. VA application 108a then initiates a dialogue workflow to interact with the user in order to capture information that will assist in routing the chat-based communication session to a live agent that is best equipped to handle the user's queries.

As part of the dialogue workflow, VA application 108a captures (step 204) a topic value and a user message from the chat-based communication session. In some embodiments, to capture the topic value, VA application 108a is configured to display a list of topics to the user in the chat session from which the user can select the topic that is most applicable to the reason for the user's request to transfer to a live agent. The list of topics can be generated by VA application 108a according to any of a number of different techniques. In one example, VA application 108a can select the most frequently selected topics across the entire userbase.

In another example, VA application 108a can determine one or more context features associated with the current chat-based communication session with the user and select the list of topics based upon the context features. Context features include, but are not limited to, a hardware device through which the user is participating in the chat session (e.g., native app or browser on mobile device/desktop, etc.), an application or feature set made available by server computing device that the user accessed prior to initiating the chat session (e.g., portfolio management, account balances, trading, research, etc.), user-specific profile information (e.g., demographics, accounts or products registered to the user, transaction history, etc.), prior chat exchanges between the user and the VA during the session, etc. VA application 108a can utilize one or more of these context features to identify a list of topics that may be most relevant in addressing the user's queries when the request to transfer is made.

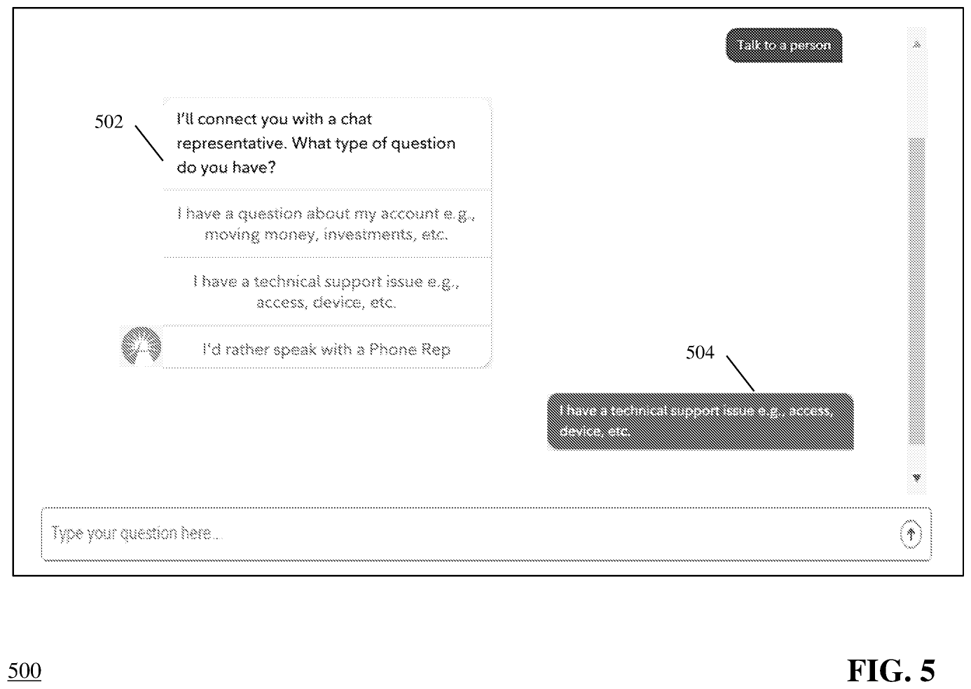

FIG. 5 is a diagram of an exemplary user interface 500 for the chat-based communication session that shows a list of topics 502 generated by VA application 108a. As shown in FIG. 5, the list of topics 502 includes a plurality of options from which the user can select one that most closely relates to the reason for the initial chat session and/or the reason for transferring to the live agent. In response to display of the list of topics, the user at client computing device 102a-102n can select one of the options, which generates user message 504 comprising the selected option. VA application 108a receives user message 504 from client computing device 102a-102n and captures the message as the topic value.

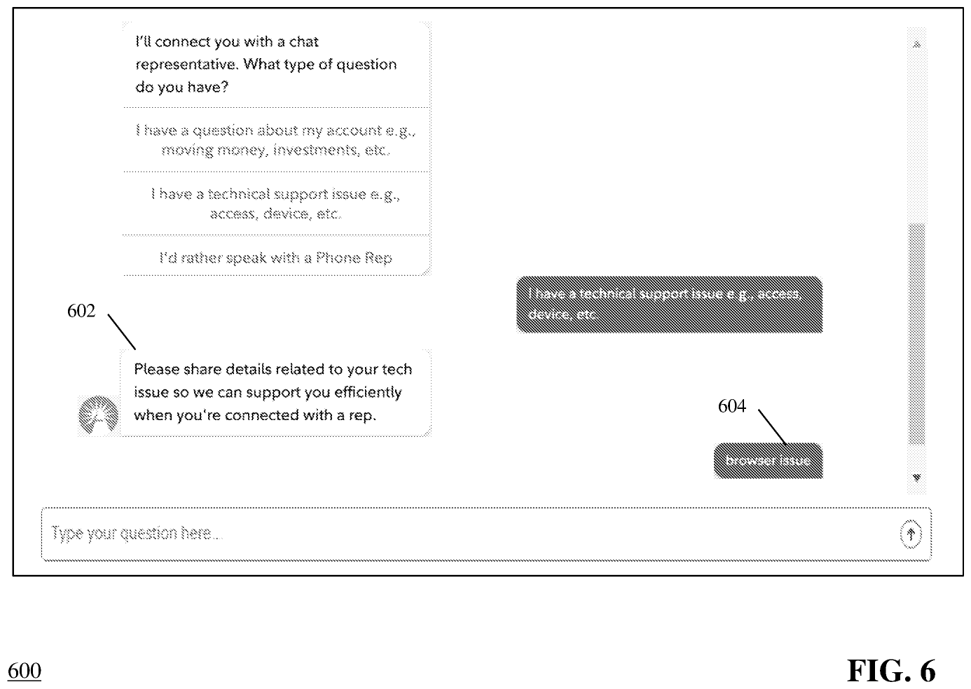

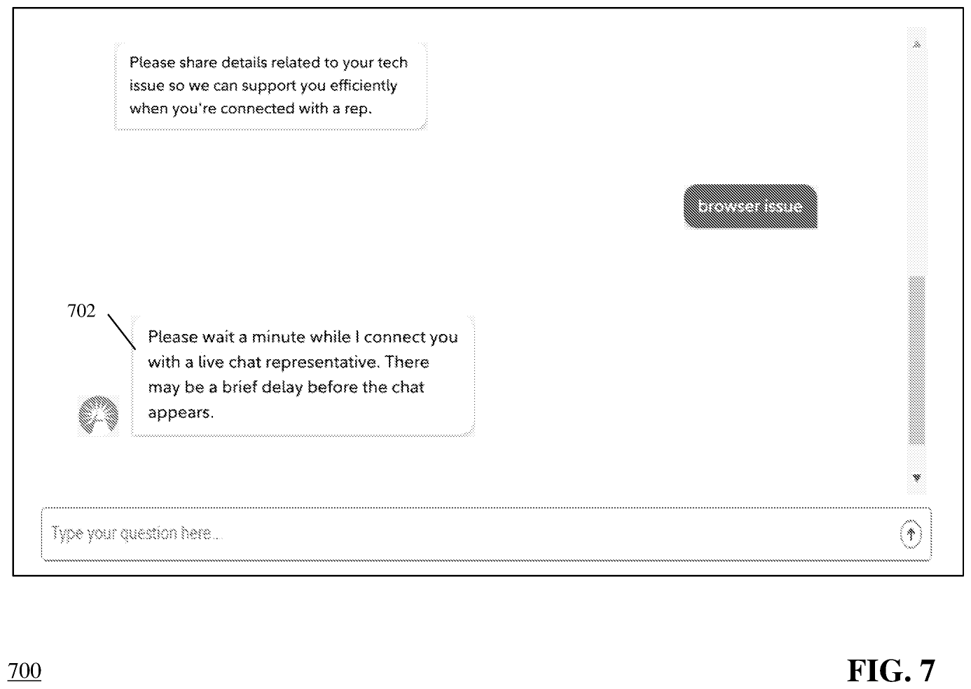

After capturing the topic, VA application 108a prompts the user to supply additional information about their issue in the form of a chat message. FIG. 6 is a diagram of an exemplary user interface 600 for the chat-based communication session that shows an information request message (i.e., prompt 602) requesting details about the user's issue and the corresponding response 604 from the user. As shown, the user has entered the text “browser issue” as message 604. VA application 108a detects the user input immediately following the information request message 602 and captures the text as the user message. VA application 108a then passes the captured user message to NLP module 108b for classifying the user intent and determining an agent that should receive the chat-based communication session. In embodiments where NLP module 108b is located on a separate computing device, VA application 108a can transmit the user message to NLP module 108b by initiating an application programming interface (API) call to NLP module, where the call includes the user message as a parameter or in a payload packet of the transmission. While the user intent is identified and an agent is selected to participate in the chat-based communication session, VA application 108a can inform the user that the connection is taking place. FIG. 7 is a diagram of an exemplary user interface 700 for the chat-based communication session that shows message 702 informing the user that a connection to a live agent is in process.

In some embodiments, VA application 108a performs one or more preprocessing steps on the incoming message prior to transmitting the message to NLP module 108b. In some embodiments, VA application 108a converts the message from a text string to another format (e.g., a machine-readable format) that is suitable for input to the trained intent classification model 110. For example, VA application 108a can convert the text string to a vectorized format (such as a multidimensional vector comprised of numeric values) that can be ingested by model 110 for purposes of generating a predicted intent of the input. In some embodiments, the conversion of the user message to a machine-readable format can be performed by NLP module 108b prior to execution of model 110. In some embodiments, VA application 108a can also capture user context data elements associated with the chat-based communication session and transmit one or more of the context data elements to NLP module 108b for identification of the user intent. User context data generally relates to information associated with the user of client computing device 102a-102n and/or information associated with the client computing device 102a-102n itself that can help refine the identification of user intent. For example, users that are associated with certain user context data may be more likely to have certain user intent when communicating with server computing device 106. As a result, intent classification model 110 can be trained according to the user context data to produce a more accurate prediction of user intent for incoming messages. Exemplary user context data can include, but is not limited to, profile information associated with the user of the client computing device (e.g., demographics, account information, transaction history, etc.), device information associated with the client computing device (e.g., mobile device, desktop), or a contact channel associated with the chat-based communication session (e.g., application module, webpage, etc.).

NLP module 108b then identifies (step 206) a user intent associated with the user message by applying the trained intent classification model 110 to the input user message. NLP module 108b executes intent classification model 110 using the user message as input to generate a predicted user intent associated with the message. As mentioned above, in some embodiments NLP module 108b and trained intent classification model 110 can leverage an external NLP framework such as Google® Dialogflow™, Amazon® Lex™, and Microsoft® Azure Bot™ that has been trained on domain-specific training data (e.g., historical user messages and known intents that correspond to the messages) to determine user intents in a given application or workflow context. In some embodiments, NLP module 108b can also incorporate one or more of the context data elements to produce a more refined prediction of the user intent (e.g., by clustering users with similar context data). NLP module 108b executes model 110, which generates a value corresponding to a predicted user intent. The generated value can be a numeric value that corresponds to a likelihood for a given user intent (such as a number between 0 and 1 or a percentage value), a label that corresponds to a given user intent, or other types of output values. When NLP module 108b determines a user intent for the input user message, NLP module 108b returns the user intent to VA application 108a.

In some embodiments, NLP module 108b may be unable to identify a user intent associated with the input message. For example, trained intent classification model 110 may determine that the predicted user intent value is not high enough for the model to be confident that the prediction should be used. In these situations, model 110 may not return any user intent values for the input message or provide indicia to NLP module 108b that a user intent could not be determined. NLP module 108b can indicate to VA application 108b that no intent is identified for the input message. Further detail about system 100 processing for each of these scenarios (intent identified and no intent identified) is provided below.

As noted above, when model 110 is able to identify a user intent for the user message, NLP module 108b transmits the user intent to VA application 108a. VA application 108b then selects (step 208a) an agent to receive the chat-based communication session based upon the user intent and a complexity value associated with the user intent. It should be understood that certain user intents can correspond to more complex queries or transactions (from the perspective of the agent), while other user intents can correspond to simpler queries or transactions. Generally, a complex intent can require more time, experience, or knowledge on the part of the agent, or require the agent to have a particular skill set and/or access to specific resources than a simple intent. As just one example, a user may want to have a conversation with a live agent to update their email address in their user profile, which can be handled quickly and does not require specialized knowledge (i.e., a simple intent)-but another user may want to get specific information or advice on a product type (e.g., cryptocurrency) which requires the agent to have specialized training and knowledge (i.e., a complex intent). Therefore, it is advantageous to be able to route each of these users to an agent that is equipped to efficiently handle their requests.

To accomplish this, VA application 108a analyzes the user intent received from NLP module 108b to determine a complexity value associated with the user intent. In some embodiments, VA application 108a can employ a mapping table to associate a user intent with a complexity value. For example, each intent can be mapped to a complexity value and VA application 108a can perform a lookup against the mapping table to identify the complexity value. In some embodiments, the complexity value is a binary value (e.g., 0=simple, 1=complex). In other embodiments, the complexity value is a more granular value (e.g., between 0 (simple) and 10 (complex)) in order to distinguish between various agents with different experience, training, knowledge, and/or skill sets. For example, a first agent may be able to handle user intents with a complexity value between 0 and 3 while another agent may be able to handle user intents with complexity value between 0 and 8. In addition, certain high performing agents or very experienced agents may be prioritized for more complex intents and therefore VA application 108a is configured to avoid routing chat-based communication sessions that have a low complexity value to these agents.

In some embodiments, VA application 108a can associate the user intent received from NLP module 108b with a category and then determine the complexity value based upon the category. For example, a plurality of user intents may correspond to a first product category (e.g., cryptocurrency) that is considered high complexity, while another plurality of user intents may correspond to a second product category (e.g., trading accounts) that is considered low complexity. VA application 108a can assign the complexity value based upon the category for the intent and/or determine a relative complexity value for the user intent within the specifically assigned category (as certain intents in a category may be more complex than others). It should be appreciated that the above determinations of complexity are merely exemplary and other methodologies for determining a complexity for a given user intent can be employed within the context of the technology described herein.

Once the complexity value is determined, VA application 108a identifies one or more agents at agent computing devices 112a-112n to which the chat-based communication session can be routed. In some embodiments, VA application 108a identifies one or more agents as candidates for receiving the chat-based communication session based upon the user intent. For example, VA application 108a can search agent profiles for a plurality of agents and identify a subset of those agents that are eligible or capable of handling a chat-based communication session associated with the identified intent. As mentioned above, the list of candidates can be further refined based upon the complexity value for the user intent. In some embodiments, VA application 108a determines a confidence level (i.e., a score that indicates the likelihood that the agent will be able to successfully service the user requests in the chat session) for each of the candidate agents using the complexity value. For example, when the complexity value is high, VA application 108a can analyze the agent profile information for the candidate agents and determine that only two of the candidate agents are likely to provide the necessary service for optimally resolving the user's questions and providing a satisfactory outcome because only those two agents have a particular skill set that corresponds to the user intent. VA application 108a determines a confidence level for those two agents that exceeds a minimum threshold for routing the session. In some embodiments, the minimum threshold is based directly or indirectly upon the complexity value. Other candidate agents that do not have the necessary skill set are given a confidence level that falls below the minimum threshold for routing the session. Therefore, VA application 108a excludes these candidate agents from further consideration in where to route the chat session. In another example, when the complexity value is low, VA application 108a can determine that most or all of the candidate agents are likely to provide adequate service for the user. As a result, VA application 108a determines a confidence level for these agents that exceeds a minimum threshold and continues with the routing determination.

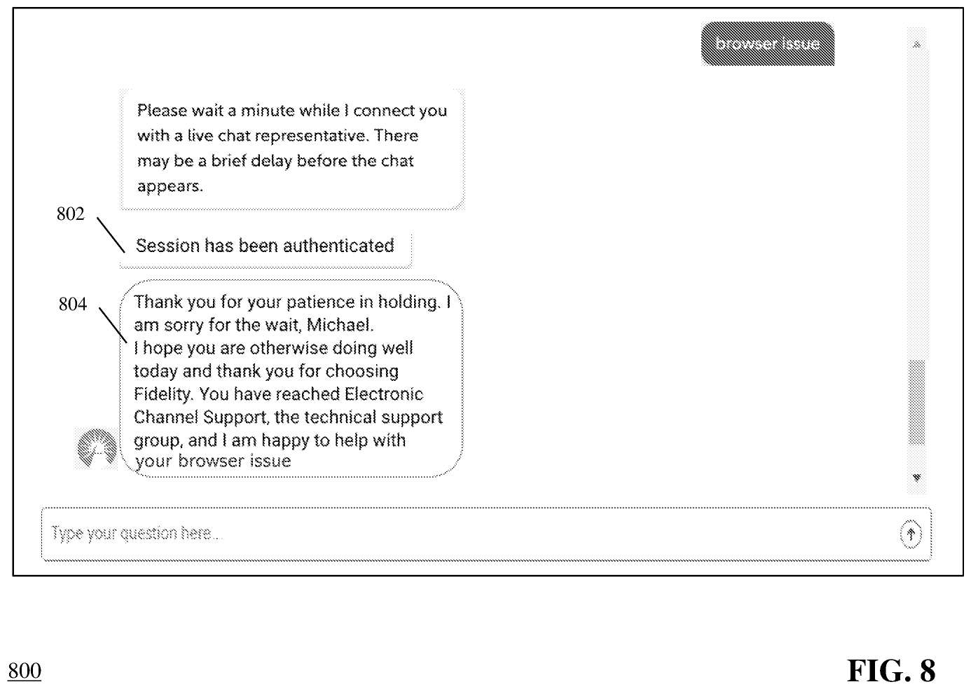

Based upon the remaining candidate agents that are eligible to receive the chat session, VA application 108a selects an agent and connects (step 208b) an agent computing device 112a-112n associated with the selected agent to the chat-based communication session. In some embodiments, VA application 108a establishes a second communication session with agent computing device 112a-112n for the selected agent and joins agent computing device 112a-112n to the first communication session established with client computing device 102a-102n. When the agent successfully resolves the user's questions and/or concludes their participation in the chat session, VA application 108a can resume the conversation with the user (if necessary). In some embodiments, VA application 108a can establish a direct or indirect connection between client computing device 102a-102n and agent computing device 112a-112n so the respective devices can continue the chat-based communication session directly. FIG. 8 is a diagram of an exemplary user interface 800 for the chat-based communication session after an agent has been selected and the session has been routed to agent computing device 112a-112n. As shown in FIG. 8, VA application 108a displays a message 802 informing the user that the chat session with the live agent is authenticated and connected. The agent at agent computing device 112a-112n can then provide an introduction message 804 to the user and proceed with the live conversation to address the user's questions and issues.

In some embodiments, one or more agents can be connected to multiple chat sessions with different users concurrently. For example, an agent may be capable of handling a plurality of chat sessions with intents that are labeled by NLP module 108b as low complexity. When selecting agents to receive a chat session, VA application 108a can determine that even though a given agent is currently connected to a session with a first user, that agent is eligible to receive a second chat session with another user because the intents associated with each of the chat sessions are associated with a certain complexity value. In this way, system 100 can efficiently route a higher volume of chat sessions to agents, instead of limiting each agent to one chat session at a time. This results in improved throughput for the chat sessions, lower wait times, and increased customer satisfaction.

As mentioned above, in some instances NLP module 108b and intent classification model 110 may not be able to determine a user intent for a given user message. However, VA application 108a can still select an agent to receive the chat-based communication session and route the session to the agent based upon the topic selected by the user (as described with respect to FIG. 5). Turning back to FIG. 2, when a user intent is not identified by model 110, VA application 108a selects (step 210a) an agent to receive the chat-based communication session based upon the topic value. In some embodiments, VA application 108a identifies a plurality of candidate agents based upon the topic value. For example, VA application 108a can scan agent profile information to determine one or more candidate agents that are assigned to a particular technology or product group that matches the selected topic. Using the list of candidate agents, VA application 108a can select one of the candidate agents to receive the chat-based communication session. In some embodiments, VA application 108a can select the agent to receive the chat session using any of a number of different routing techniques (e.g., at random, based upon load balancing considerations, based upon time zone considerations, and so forth). VA application 108a then connects (step 210b) the agent computing device 112a-112n associated with the selected agent to the chat-based communication session.

Another aspect of the technology described herein is the ability of system 100 to make routing decisions based upon availability of agents for certain intents or topics, and if no appropriate agents are available at the current time, to inform the user. As can be appreciated, due to the limited availability of specifically trained agents, it may be beneficial to prioritize routing of chat sessions that are associated with high priority intents/topics and/or those intents/topics for which agents are required to be available at all times (e.g., due to regulatory or business considerations). Also, the number of live agents available to service user requests may be lower or zero at certain times of day—for example, live agents may only be staffed to receive incoming chat requests during defined operating hours (e.g., 9:00 am to 7:00 pm). Therefore, system 100 should be configured to determine agent availability based upon at least the above considerations and route chat sessions accordingly (if possible) or provide an indication to the user that a live chat session is unavailable.

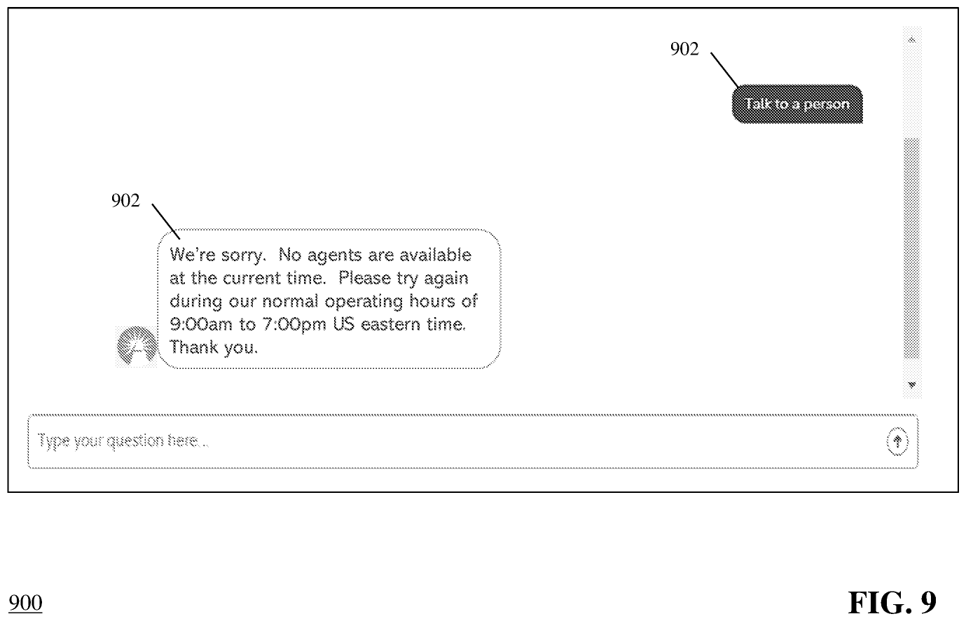

As can be appreciated, in some embodiments the determination of agent availability occurs upon initiation of the request for a live chat session by the user at client computing device 102a-102n. In the scenario where no agents are available because the request is submitted outside of normal operating hours, VA application 108a can compare a timestamp of the live chat session request from the client computing device 102a-102n to a data structure that contains the operating hours for one or more live agents or live agent groups. VA application 108a confirms that the timestamp is outside of the operating hours range. As a result, VA application 108a can display a graceful error message to the user. FIG. 9 is a diagram of an exemplary user interface 900 of the chat-based communication session when VA application 108a determines that no agents are available after receiving a request for a live chat session. After the user submits message 902 for connection to a live agent, VA application 108a responds with a message 904 asking the user to try again at a different time.

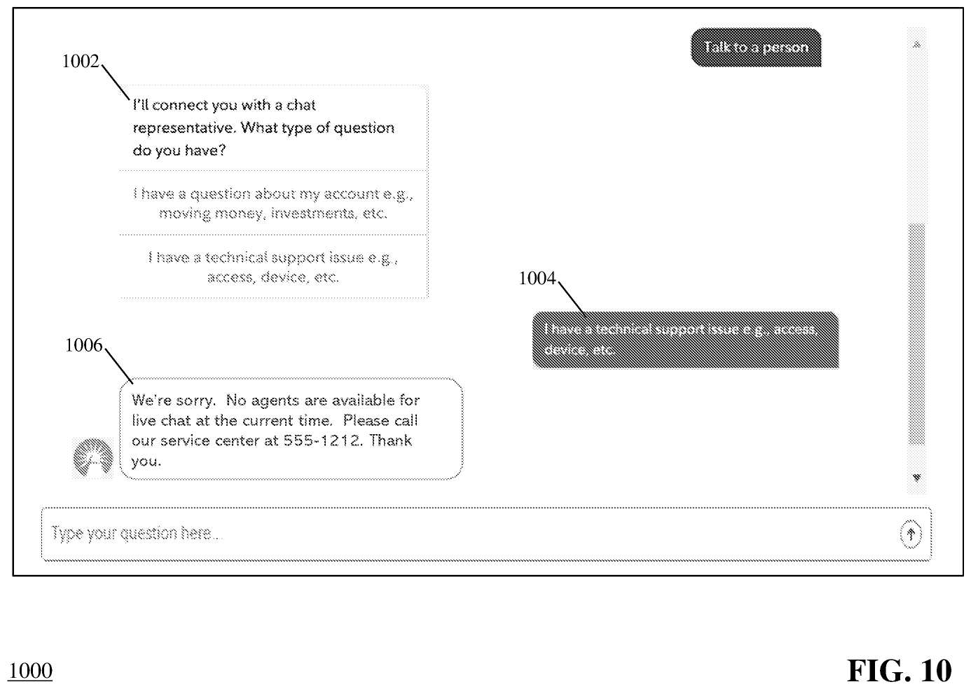

Alternatively, all agents associated with a particular intent or topic may be conducting chat sessions with other users and/or live agent availability may be restricted to only specific intents or topics. VA application 108a can determine that no agents are available to service the user request after determining the topic and/or intent for the chat session. In the scenario where no agents are available for one or more topics, VA application 108a receives the selection of a topic from client computing device 102a-102n and confirms that no agents are available for that topic. As a result, VA application 108a can display a graceful error message to the user. FIG. 10 is a diagram of an exemplary user interface 1000 of the chat-based communication session when VA application 108a determines that no agents are available after receiving a topic selection from client computing device 102a-102n. After the user selects a topic 1004 from list 1002, VA application 108a determines that no agents are available for live chat and responds with a message 1006 asking the user to call a customer service center. It should be appreciated that the same processing and error message can be displayed by VA application 108a upon determining that no agents are available for servicing a user request associated with a specific intent and/or that no agents are available that meet a specified confidence level for the intent.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A computer system for intent-aware virtual assistant chat routing, the system comprising a server computing device having a memory that stores computer-executable instructions and a processor that executes the computer-executable instructions to:
receive a request from a user of a client computing device to transfer a chat-based communication session from a virtual assistant application to an agent;
capture a topic value and a user message from the chat-based communication session;
identify a user intent associated with the user message by applying a trained intent classification model to the user message;
when a user intent is identified:
select an agent to receive the chat-based communication session based upon the user intent and a complexity value associated with the user intent, and
connect an agent computing device associated with the selected agent to the chat-based communication session; and
when a user intent is not identified:
select an agent to receive the chat-based communication session based upon the topic value, and
connect an agent computing device associated with the selected agent to the chat-based communication session.

2. The system of claim 1, wherein capturing a topic value comprises:
presenting a plurality of selectable topic values in the chat-based communication session;
detecting user input that corresponds to one of the selectable topic values in the chat-based communication session; and
capturing the selected topic value from the chat-based communication session.

3. The system of claim 2, wherein capturing a user message comprises:
presenting an information request message in the chat-based communication session;
detecting user input in response to the information request message in the chat-based communication session; and
capturing the user input as the user message.

4. The system of claim 3, wherein the detected user input comprises a chat message or a spoken utterance.

5. The system of claim 1, wherein identifying a user intent associated with the user message by applying a trained intent classification model to the user message comprises:
converting the user message into a machine-readable format suitable for input to the trained intent classification model;
executing the trained intent classification model using the converted user message to generate an intent classification for the converted user message; and
identifying the user intent based upon the intent classification.

6. The system of claim 5, wherein selecting an agent to receive the chat-based communication session based upon the user intent and a complexity value associated with the user intent comprises:
identifying one or more agents as candidates for receiving the chat-based communication session based upon the user intent;
determining a confidence level for each of the identified agents using the complexity value; and
selecting one of the identified agents to receive the chat-based communication session based upon the confidence level.

7. The system of claim 6, wherein the server computing device does not select any of the identified agents when the confidence level for each of the identified agents falls below a threshold.

8. The system of claim 1, wherein the server computing device captures a user context associated with the chat-based communication session and identifies the user intent associated with the user message by applying a trained intent classification model to the user message and the user context.

9. The system of claim 8, wherein the user context comprises one or more of: profile information associated with the user of the client computing device, device information associated with the client computing device, or a contact channel associated with the chat-based communication session.

10. The system of claim 1, wherein the server computing device determines an agent availability based upon the captured topic.

11. The system of claim 10, wherein determining an agent availability based upon the captured topic comprises:
determining an agent service window associated with the captured topic;
comparing a current time to the agent service window; and
determining that no agents are available for the captured topic when the current time is outside the agent service window.

12. The system of claim 11, wherein the server computing device presents alternative agent contact information in the chat-based communication session upon determining that no agents are available for the captured topic.

13. The system of claim 12, wherein the server computing device ends the chat-based communication session upon determining that no agents are available for the captured topic.

14. The system of claim 1, wherein an agent computing device is concurrently connected to a plurality of chat-based communication sessions with different client computing devices when the complexity value associated with the user intent of each of the plurality of chat-based communication sessions is below a threshold.

15. A computerized method of intent-aware virtual assistant chat routing, the method comprising:
receiving, by a server computing device, a request from a user of a client computing device to transfer a chat-based communication session from a virtual assistant application to an agent;
capturing, by the server computing device, a topic value and a user message from the chat-based communication session;
identifying, by the server computing device, a user intent associated with the user message by applying a trained intent classification model to the user message;
when a user intent is identified:
selecting, by the server computing device, an agent to receive the chat-based communication session based upon the user intent and a complexity value associated with the user intent, and
connecting, by the server computing device, an agent computing device associated with the selected agent to the chat-based communication session; and
when a user intent is not identified:
selecting, by the server computing device, an agent to receive the chat-based communication session based upon the topic value, and
connecting, by the server computing device, an agent computing device associated with the selected agent to the chat-based communication session.

16. The method of claim 15, wherein capturing a topic value comprises:
presenting a plurality of selectable topic values in the chat-based communication session;
detecting user input that corresponds to one of the selectable topic values in the chat-based communication session; and
capturing the selected topic value from the chat-based communication session.

17. The method of claim 16, wherein capturing a user message comprises:
presenting an information request message in the chat-based communication session;
detecting user input in response to the information request message in the chat-based communication session; and
capturing the user input as the user message.

18. The method of claim 17, wherein the detected user input comprises a chat message or a spoken utterance.

19. The method of claim 15, wherein identifying a user intent associated with the user message by applying a trained intent classification model to the user message comprises:
converting the user message into a machine-readable format suitable for input to the trained intent classification model;
executing the trained intent classification model using the converted user message to generate an intent classification for the converted user message; and
identifying the user intent based upon the intent classification.

20. The method of claim 19, wherein selecting an agent to receive the chat-based communication session based upon the user intent and a complexity value associated with the user intent comprises:
identifying one or more agents as candidates for receiving the chat-based communication session based upon the user intent;
determining a confidence level for each of the identified agents using the complexity value; and
selecting one of the identified agents to receive the chat-based communication session based upon the confidence level.

21. The method of claim 20, wherein the server computing device does not select any of the identified agents when the confidence level for each of the identified agents falls below a threshold.

22. The method of claim 15, wherein the server computing device captures a user context associated with the chat-based communication session and identifies the user intent associated with the user message by applying a trained intent classification model to the user message and the user context.

23. The method of claim 22, wherein the user context comprises one or more of: profile information associated with the user of the client computing device, device information associated with the client computing device, or a contact channel associated with the chat-based communication session.

24. The method of claim 15, wherein the server computing device determines an agent availability based upon the captured topic.

25. The method of claim 24, wherein determining an agent availability based upon the captured topic comprises:
determining an agent service window associated with the captured topic;
comparing a current time to the agent service window; and
determining that no agents are available for the captured topic when the current time is outside the agent service window.

26. The method of claim 25, wherein the server computing device presents alternative agent contact information in the chat-based communication session upon determining that no agents are available for the captured topic.

27. The method of claim 26, wherein the server computing device ends the chat-based communication session upon determining that no agents are available for the captured topic.

28. The method of claim 15, wherein an agent computing device is concurrently connected to a plurality of chat-based communication sessions with different client computing devices when the complexity value associated with the user intent of each of the plurality of chat-based communication sessions is below a threshold.
